(19) United States
(12) Patent Application Publication
(10) Pub. No.: US 2018/0128667 A1
(43) Pub. Date: May 10, 2018

(54) SYSTEM AND METHOD FOR MEASURING PRODUCT QUANTITY IN A CONTAINER

(71) Applicant: WESTROCK MWV, LLC, Norcross, GA (US)

(72) Inventor: Caleb S. LOFTIN, Richmond, VA (US)

(73) Assignee: WestRock MWV, LLC, Norcross, GA (US)

(21) Appl. No.: 15/564,237

(22) PCT Filed: Jun. 19, 2015
(86) PCT No.: PCT/US2015/036543

§ 371 Date: Oct. 4, 2017

Related U.S. Application Data
(60) Provisional application No. 62/155,498, filed on May 1, 2015.

(51) Int. Cl. G01F 15/18; G01F 17/00; G01F 23/292

(52) U.S. Cl. CPC G01F 15/18; G01F 11/284; G01F 23/2925; G01F 17/00

(57) ABSTRACT

A system for measuring product quantity may include a first plurality of sensor assemblies and a second plurality of sensor assemblies, the second plurality of sensor assemblies being laterally opposed to and aligned with the first plurality of sensor assemblies, wherein opposed pairs of sensor assemblies are configured to detect a presence of a product disposed between the opposed pairs of sensor assemblies.

### BACKGROUND OF THE INVENTION

### Field of the Invention

This application relates to product dispensing and, more particularly, to systems and methods for determining the quantity of products in a container, such as a container associated with a product dispensing system.

### State of the Art

Products are typically shipped to retailers in bulk by enclosing multiple individual product units in a container, such as a carton or box. For example, canned foods may be shipped to a retailer in a box containing twelve individual cans. Then, it is typically the retailer's obligation to remove the individual product units from the container and present them to consumers on a display (e.g., a shelf).

Product dispensing systems have been developed in an effort to improve operating efficiency over the traditional package-ship-unpack-display model. Product dispensing systems are described in greater detail in U.S. Pat. No. 7,922,437 to Loftin et al. The Loftin product dispensing system includes a dispenser having a frame and an opening tool. The dispenser may be positioned on a retailer's shelf and loaded with product simply by placing a container comprising multiple units of product onto the frame of the dispenser. As the container is being placed onto the frame, the opening tool of the dispenser automatically opens the container such that products move under the force of gravity from the container down to a product display area of the frame.

Many retailers periodically conduct an audit, which requires ascertaining the retailer's inventory at a given time. Taking inventory typically involves counting the total number of each product (e.g., each SKU) the retailer has on hand. When products are presented in the traditional way, taking inventory may require counting each product sitting on the display. When product dispensing systems are used, taking inventory may require the additional step of removing the container from the dispenser and examining the number of products within the container. Therefore, taking inventory may a labor-intensive and costly process.

Accordingly, those skilled in the art continue with research and development efforts in the field of product dispensing.

### BRIEF SUMMARY OF THE INVENTION

In one embodiment, the disclosed system for measuring product quantity may include a first plurality of sensor assemblies and a second plurality of sensor assemblies, the second plurality of sensor assemblies being laterally opposed to and aligned with the first plurality of sensor assemblies, wherein opposed pairs of sensor assemblies are configured to detect a presence of a product disposed between the opposed pairs of sensor assemblies.

In another embodiment, the disclosed system for measuring product quantity may include a container that defines an internal volume, a plurality of products positioned in the internal volume, and a product detector including a first plurality of sensor assemblies positioned proximate the container and a second plurality of sensor assemblies positioned proximate the container, wherein opposed pairs of sensor assemblies are configured to detect a presence of the product disposed between the opposed pairs of sensor assemblies.

In another embodiment, the disclosed method for determining a number of products in a container may include the steps of (1) positioning the container between a first plurality of sensor assemblies and a second plurality of sensor assemblies, (2) actuating the first and second plurality of sensor assemblies, (3) sensing a condition of opposed pairs of sensor assemblies, and (4) correlating the condition of the opposed pairs of sensor assemblies to the number of products in the container.

Other embodiments of the disclosed system and method for measuring product quantity in a container will become apparent from the following detailed description, the accompanying drawings and the appended claims.

### BRIEF DESCRIPTION OF THE DRAWINGS

FIG. 1 is a schematic top plan view of one embodiment of the disclosed system for measuring product quantity;

FIG. 2 is a rear elevational view of the disclosed system of FIG. 1;

FIG. 3 is a schematic top plan view of one embodiment of the product detector of the disclosed system for measuring product quantity;

FIG. 4 is a rear elevational view of the disclosed product detector of FIG. 3;

FIG. 5 is a front and side perspective view of the container of the system of FIG. 1;

FIG. 6 is a schematic rear elevational view of another embodiment of the disclosed system for measuring product quantity;

FIG. 7 is a schematic block diagram of the disclosed product detector of FIG. 3;

FIG. 8 is a side and front perspective view of the disclosed product detector of FIG. 3;

FIG. 9 is a side and front perspective view of the disclosed system of FIG. 1;

FIG. 10 is a side and front perspective view of a product dispensing system incorporating the disclosed system for measuring product quantity; and

FIG. 11 is a side elevational view, in section, of the dispenser of the product dispensing system of FIG. 10.

### DETAILED DESCRIPTION OF THE INVENTION

The following detailed description refers to the accompanying drawings, which illustrate specific embodiments of the disclosure. Other embodiments having different structures and operations do not depart from the scope of the present disclosure. Like reference numerals may refer to the same element or component in the different drawings.

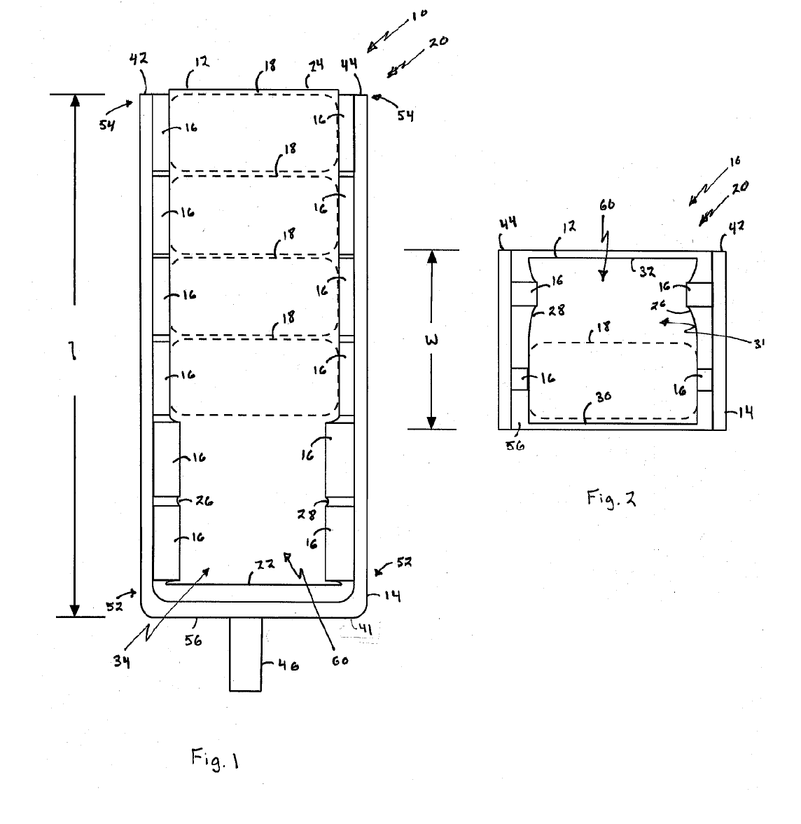

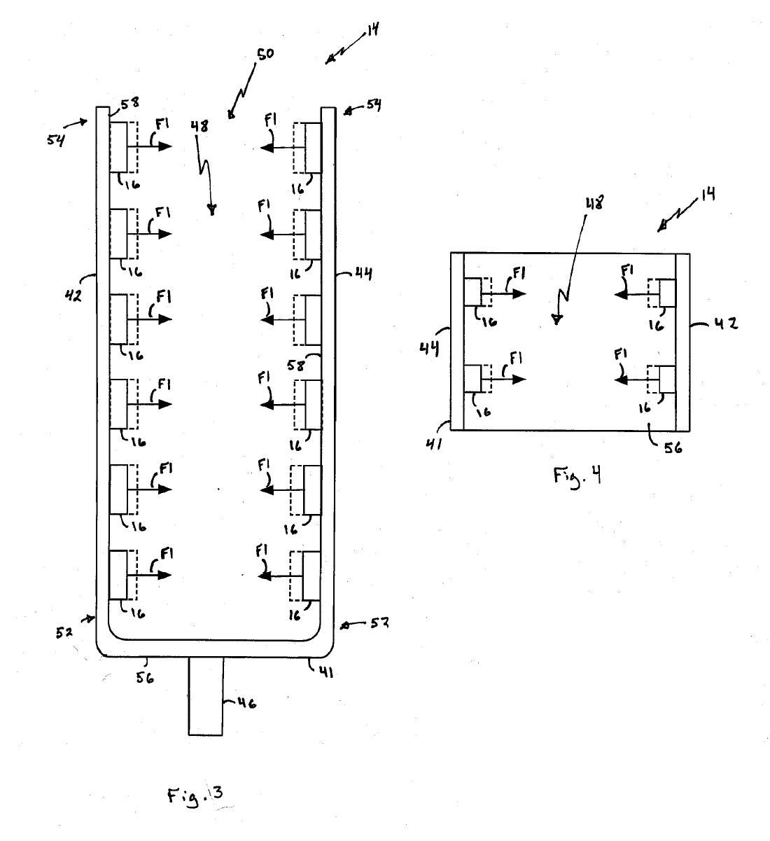

Referring to FIGS. 1-4, one embodiment of the disclosed system for measuring product quantity, generally designated 10, may include a container 12 and a product detector 14. The product detector 14 may be positioned proximate (e.g., at or near) the container 12, thereby effectively forming a product-detecting assembly 20 (FIGS. 1 and 2). The product detector 14 may include a plurality of sensor assemblies 16 configured to detect the presence of product 18 within the container 12 in response to a force F1 (illustrated by an arrow in FIGS. 3 and 4) applied to the container 12, thereby providing an indication of the quantity of products 18 (e.g., the number of products 18, if any) housed in the container 12.

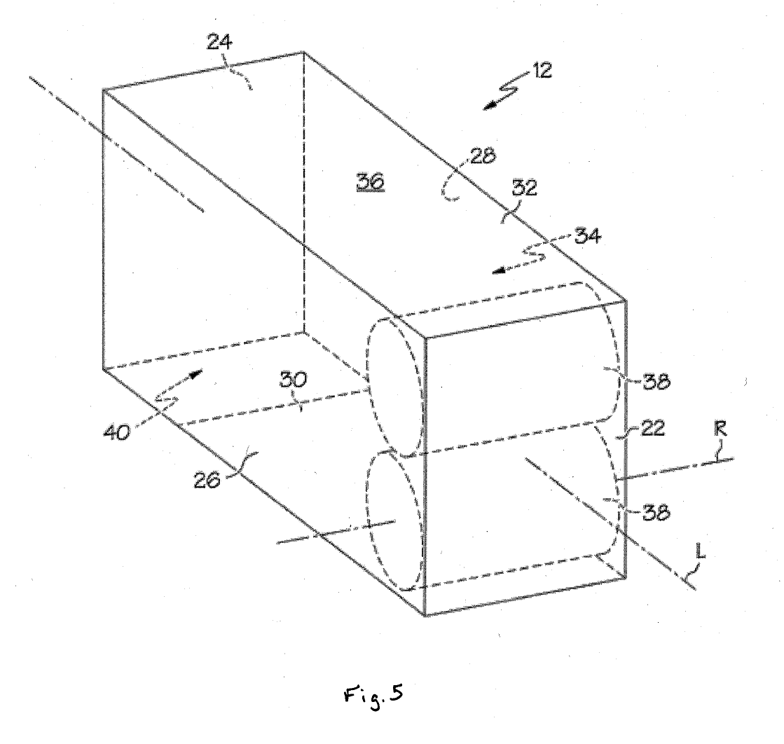

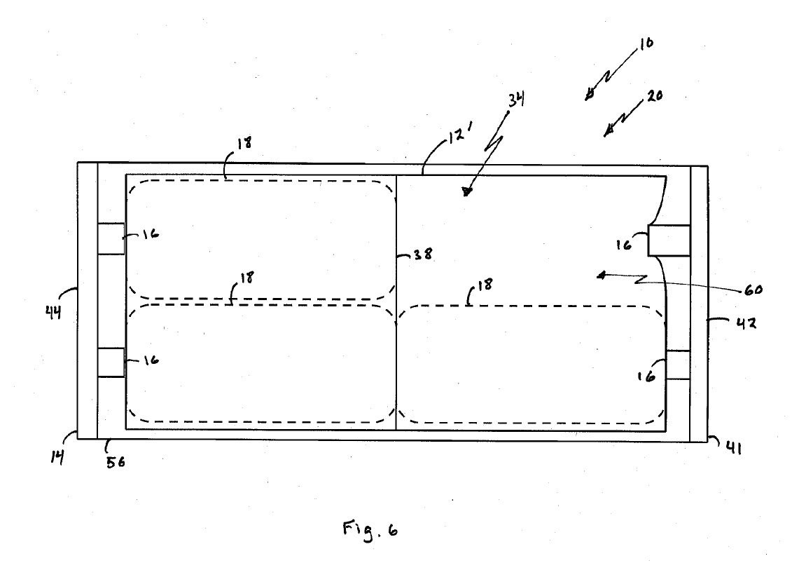

Referring to FIG. 5, the container 12 may be a generally rectilinear container having a longitudinal axis L. The container 12 may be elongated along the longitudinal axis L, and may include six walls 22, 24, 26, 28, 30, 32 that define an internal volume 34. Opposed walls may define the front wall 22 and the rear wall 24 of the container 12. Opposed walls 26 and 28 may define the first (e.g., left) side wall 26 and the second (e.g., right) side wall 28 of the container 12. Opposed walls may define the base wall 30 and the upper wall 32 of the container 12.

The container 12 may be assembled on a container machine or the like using a container blank that has been pre-cut from a sheet of stock material. As one example, the stock material may be a paperboard-based material, such as C1S paperboard, which may have a coating (e.g., clay) on a first major surface thereof (e.g., the outer surface 36). Optionally, the outer surface 36 of the container 12 may be marked with various indicia, such as advertising text and/or graphics. As another example, the stock material may be C2S paperboard, which may have a coating (e.g., clay) on both major surfaces thereof. Other materials, such as corrugated board, polymeric materials and the like may be used to construct the container 12 without departing from the scope of the present disclosure.

Various products 18 may be housed in the internal volume 34 of the container 12. Non-limiting examples of suitable products 18 include cans (e.g., canned soup or pet food), jars (e.g., jarred sauce) or bottles (e.g., bottled soft drinks). The products 38 may be capable of rolling about a rolling axis R.

The products 18 may be arranged in various ways within the container 12. As one example, the products 18 may be arranged in a single longitudinal row, with only one row of products 18 between opposing walls of the container 12 (e.g., between the side walls 26, 28), as shown in FIG. 1. As another example, the products 18 may be arranged in two stacked longitudinal rows, with only one row of products 18 between opposing walls of the container 12 (e.g., between the side walls 26, 28), as shown in FIG. 2. As another example, a first stacked longitudinal row of products 18 may be laterally adjacent to a second stacked longitudinal row or products, 18 as shown in FIG. 6. A divider 38 may optionally separate the laterally adjacent rows of products 18 within the container 12′.

Still referring to FIG. 5, the container 12 may define a container opening 40 that may provide access to the products 18 housed in the internal volume 34 of the container 12. The container opening 40 may be sized and shaped to allow products 18 to pass therethrough. For example, the container opening 40 may be formed in the base wall 30 proximate the rear wall 24, such that the container 12 may be used in a product dispensing system having a dispenser, as described in greater detail below.

Optionally, the container opening 40 may be initially covered by a tear-away access panel, a peelable label or the like (not shown). Therefore, the container opening 40 may be manually formed prior to dispensing (or otherwise removing) products 18 from the container 12. Alternatively, the container opening 40 may be automatically formed in the container 12 upon loading the container 12 onto a dispenser (discussed below).

Referring back to FIGS. 3 and 4, the product detector 14 may include a body 41 that is generally Y-shaped (e.g., cross-sectional shape). The body 41 of the product detector 14 may include a first arm 42, a second arm 44, and a handle 46. The first 42 and second 44 arms may be parallel and laterally spaced apart a predetermined distance defining a central open region 48. The open region 48 may be suitably sized to receive the container 12 (FIGS. 1 and 2). The spaced apart distance between the first 42 and second 44 arms may be sufficiently greater than the width of the container 12 (e.g., the distance between left side wall 26 and right side wall 28) such that the container 12 fits between the arms 42, 44.

Each of the arms 42, 44 may include a first end 52 and a longitudinally opposed second end 54 (FIG. 3). The first ends 52 of the arms 42, 44 may be interconnected by a crossmember 56. For example, the arms 42, 44 may be connected at opposing ends of the crossmember 56. The second ends 54 may define an opening 50 therebetween. The opening 50 may be configured to receive the container 12 (FIG. 1) in order to position the container 12 within the open region 48 between the opposed arms 42, 44.

The first arm 42 may include a first plurality of sensor assemblies 16 and the second arm 44 may include a second plurality of sensor assemblies 16. Each plurality of sensor assemblies 16 may be aligned with one another and spaced apart along an interior surface 58 (FIG. 3) of each arm 42, 44. Each sensor assembly 16 of the plurality of sensor assemblies 16 may be positioned upon the arms 42, 44 in in such a manner as to align opposed pairs of sensor assemblies 16 with the positions of a full complement of products 18 housed within a full container 12 upon positioning the container 12 within the open region 48, as illustrated in FIGS. 1 and 2. For example, the sensor assemblies 16 may extend from proximate the first end 52 to proximate the second end 54 with each sensor assembly 16 aligning with a position of the product 18 along the longitudinal row of products 18.

The arms 42, 44 may be suitably sized to encompass at least a portion of two opposing walls (e.g., opposing left side wall 26 and right side wall 28) of the container 12 in order to align each sensor assembly 16 of the plurality of sensor assemblies 16 with a position of a corresponding product 18 housed within the container 12. Each of the arms 42, 44 may have a length dimension 1 and a width dimension w. The length 1 may be substantially equal to or greater than the longitudinally length of the container 12 (e.g., distance between front wall 22 and rear wall 24). The width w may be substantially equal to, greater than, or less than the height of the container 12 (e.g., distance between base wall 30 and upper wall 32).

Those skilled in the art will appreciate that the size of the sensor assemblies 16, the shape of sensor assemblies 16, the total number of sensor assemblies 16, the position of the sensor assemblies 16, and the distance each sensor assembly 16 is spaced apart from an adjacent sensor assembly 16 may depend upon a variety of factors including, but not limited to the size, shape, and type of product 18, the number of products 18 initially housed within the full container 12, the configuration or layout of the products 18 housed within the container 12, and the like.

For example, for use with a container 12 initially housing a single longitudinal row of six (6) products, the product detector 14 may include six (6) sensor assemblies 16 disposed on the interior surface 58 of each of the first 42 and second 44 arms corresponding to the location of the products 18 housed within the container 12. As another example, for use with a container 12 initially housing two stacked rows of six (6) products, the product detector 14 may include twelve (12) sensor assemblies 16 disposed in two parallel rows of six (6) sensor assemblies 16 on the interior surface 58 of each of the first 42 and second 44 arms corresponding to the location of the products 18 housed within the container 12.

Referring again to FIGS. 1-4, each sensor assembly 16 may be movable between a retracted position (shown by example in solid lines in FIGS. 3 and 4) and an extended position (shown by example in broken lines in FIGS. 3 and 4). In such a manner, a pair of opposing sensor assemblies 16 (e.g., two laterally opposed sensor assemblies 16 in parallel alignment) may clamp the container 12 (FIGS. 1 and 2) by applying a compression force F1 (FIGS. 3 and 4) upon two opposing walls (e.g., opposing left 26 and right 28 side walls) of the container 12.

As illustrated in FIGS. 1 and 2, the opposed pair of sensor assemblies 16 may differentiate between the presence of a product 18 within the container 12 disposed between the opposed pair of sensor assemblies 16 and the presence of a void 60 within the container 12 (e.g., product 18 not being present) disposed between the opposed pair of sensor assemblies 16 based upon a condition of the sensor assembly 16 (e.g., sensor assembly 16 being in the retracted or extended position).

The product detector 14 may detect the presence of a void 60 within the internal volume 34 of the container 12 upon the pair of opposed sensor assemblies 16 being in the extended position. Opposed walls of the container 12 (e.g., left 26 and right 28 side walls) may deform or flex inwardly in response to the force F1 (FIGS. 3 and 4) applied by the pair of opposed sensor assemblies 16 upon movement of the sensor assemblies 16 into the extended position. Thus, the sensor assemblies 16 being in the extended position may indicate product 18 not being present within the container 12 at a location corresponding to the pair of sensor assemblies 16.

The product detector 14 may detect the presence of a product 18 within the internal volume 34 of the container 12 upon the pair of opposed sensor assemblies 16 being in the retracted position. Opposed ends of product 18 disposed between opposed walls of the container 12 (e.g., left 26 and right 28 side walls) and between the opposed pair of sensor assemblies 16 may resist and oppose the force F1 applied by the pair of opposed sensor assemblies 16 and maintain the sensor assemblies 16 in the retracted position. Thus, the sensor assemblies 16 being in the retracted position may indicate product 18 being present within the container 12 at a location corresponding to the pair of sensor assemblies 16.

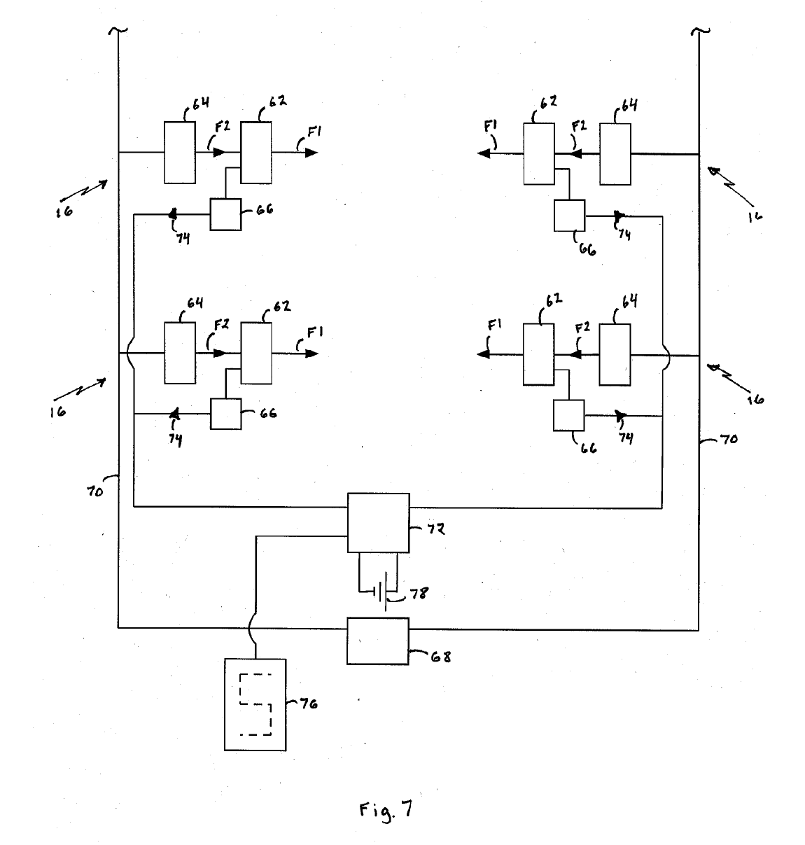

Referring to FIG. 7, in an example embodiment of the disclosed system 10, each sensor assembly 16 may include a movable element 62, a driver element 64, and a sensor element 66. The movable element 62 may be moveable between the extended position and the retracted position with respect to a corresponding arm 42, 44 (FIGS. 3 and 4). The driver element 64 may be operably connected to the moveable element 62 and configured to drive or otherwise position the moveable element 62 between the retracted and extended positions. The sensor element 66 may be operably connected to the moveable element 62 and configured to detect the presence of product 18 (FIGS. 1 and 2) based on the condition of the moveable element 62.

The driver element 64 may be operably connected to an actuator 68 by an operable connection 70. The actuator 68 may initiate movement of the moveable element 62 (e.g., a clamping action of pairs of opposed sensor assemblies 16) through the operable connection 70 between the driver element 64 associated with the moveable element 62.

The sensor element 66 may be electrically connected to a control element 72. The sensor element 66 may transmit an output signal 74 to the control element 72 in response a condition of the sensor assembly 16 (e.g., how the moveable element 62 reacts to a driving force F2 applied by the driver element 64). The control element 72 may be configured to receive the output signal 74 from each sensor element 66 and correlate (e.g., count) the output signals 74 from the plurality of sensor elements 66 to a quantity of products 18 within the container 12 (FIGS. 1 and 2). The control element 72 may be electrically connected to a display 74. The display 74 may be configured to display the quantity of products 18 within the container 12 in response to a signal provided by the control element 72.

The driver element 64 may be any suitable mechanical, electromechanical, or pneumatic device capable of applying or transferring the driving force F2 upon the moveable element 62. The moveable element 62 may be any suitable structure capable of being driven by the driver element 64 and capable of applying force F1 (FIGS. 3 and 4) upon the container 12 (FIGS. 1 and 2) by contact with an adjacent wall (e.g., left 26 or right 28 side wall) of the container 12.

The sensor element 66 may by any suitable type of sensing device capable of sensing a condition of the sensor assembly 16. The condition of the sensor assembly 16 may include, but is not limited to a change in position of the moveable element 62, a change in configuration of the moveable element 62, or any response to movement of the moveable element 62. For example, the sensor element 66 may include a position sensor configured to sense whether the moveable element 62 has moved to the extended position or has remained in the retracted position. As another example, the sensor element 66 may include a pressure sensor configured to sense a pressure applied to the moveable element 62 by product 18 resisting movement of the moveable element 62 to the extended position. As another example, the sensor element 66 may include a load cell configured to sense a force applied to the moveable element 62 by product 18 resisting movement of the moveable element 62 to the extended position. As another example, the sensor element 66 may include a strain gauge configured to sense a strain applied to the moveable element 62 by product 18 resisting movement of the moveable element 62 to the extended position. As yet another example, the sensor element 66 may be configured to sense a change in voltage or electrical current, such as a current spike that occurs when a driving motor encounters significant resistance in the driving direction.

The control element 72 may be any suitable processing unit capable of interpreting the output signal 74 provided by the sensor element 66 and converting the output signal 74 into a digital representation of the quantity of product 18 (FIGS. 1 and 2). The control element 72 may be electrically connected to a display element 76.

The display element 76 may be any suitable output device capable of presenting information (e.g., the quantity of product 18 within the container 12) in a visual form (e.g., numeric digits). The display element 76 may include, but is not limited to, a light emitting diode display, a liquid crystal display, or the like.

A power supply 78 may be electrically connected to the sensor element 66, the control element 72, and the display element 76 to provide electrical power to the product detector 14. The power supply 78 may include, but is not limited to, a battery, a solar cell, or the like.

In an example implementation, the moveable element 62 may be initially positioned in the retracted position. The actuator 68 may actuate each driver element 64 via the operable connection 70. The driver element 64 may apply the driving force F2 to the associated moveable element 62 to drive the moveable element 62 toward an adjacent wall (e.g., left side wall 26 or right side wall 28) of the container 12. Each moveable element 62 may either move to the extended position or may remain in the retracted position depending upon the presence of product 18 (FIGS. 1 and 2) disposed between opposed moveable elements 62.

Each sensor element 66 may transmit an output signal 74 to the control element 72 based on a response to a condition of the moveable element 62. For example, the output signal 74 may represent a quantity of one (1) product 18 under a first condition of the moveable element 62 (e.g., the moveable element 62 being in the retracted position or the moveable element 62 being acted upon by an opposing force due to the presence of product 18). As another example, the output signal 74 may represent a negative quantity of one (1) product 18 under a second condition of the moveable element 62 (e.g., the moveable element 62 being in the extended position or the moveable element 62 not being acted upon by an opposing force due to the presence of a void 60).

The control element 72 may visually indicate the quantity of product 18 within the container 12 (FIGS. 1 and 2) based on the output signal 74 from each sensor element 66 via the display element 76. For example, the control element 72 may count each output signal 74 representing one (1) product 18 based on the first condition of the moveable element 62. The total count of output signals 74 may represent the current measured quantity of product 18 housed within the container 12. Alternatively, the control element 72 may count each output signal 74 representing one (1) void 60 based on the second condition of the moveable element. The total count of output signals 74 may be subtracted from the quantity of product 18 initially housed in the container 12 and represent the current measured quantity of product 18 housed within the container 12.

In a first example construction, the moveable element 62 may include a contact member having a rigid body and a contact surface configured to engage and make contact with an adjacent wall (e.g., left 26 and right 28 side walls) of the container 12 (FIGS. 1 and 2). The driver element 64 may include a mechanical linkage operably connected to the contact member. The actuator 68 may be a squeeze trigger. The operable connection 70 may include a rigid member (e.g., a rod) connected between the trigger and the mechanical linkage such that engagement of the trigger may linearly move the rigid member. Movement of the rigid member may actuate the mechanical linkage to drive the contact member outward toward the container 12 (FIGS. 1 and 2). Product 18 (FIGS. 1 and 2) disposed between opposed contact members may prevent movement of the contact members, thus keeping each contact member in the retracted position and indicating the presence of product 18 detected by the sensor element 66.

In a second example construction, the moveable element 62 may include a contact member having a rigid body and a contact surface configured to engage and make contact with an adjacent wall (e.g., left 26 and right 28 side walls) of the container 12 (FIGS. 1 and 2). The driver element 64 may include a pneumatic cylinder operably connected to the contact member. The actuator 68 may be a squeeze trigger. The operable connection 70 may include pneumatic tubing connected between the trigger and the pneumatic cylinder such that engagement of the trigger may actuate the pneumatic cylinder to drive the contact member outward toward the container 12 (FIGS. 1 and 2). Product 18 (FIGS. 1 and 2) disposed between opposed contact members may prevent movement of the contact members, thus keeping each contact member in the retracted position and indicating the presence of product 18 detected by the sensor element 66.

In a third example construction, the moveable element 62 may include an inflatable air bag having a contact surface configured to engage and make contact with an adjacent wall (e.g., left 26 and right 28 side walls) of the container 12 (FIGS. 1 and 2). The driver element 64 may include an air pump operably connected to the air bag. The actuator 68 may be a squeeze trigger operably connected to the air pump. The operable connection 70 may include air tubing connected between the pump and the air bag such that engagement of the trigger may inflate the air bag to drive the contact surface outward toward the container 12 (FIGS. 1 and 2). Product 18 (FIGS. 1 and 2) disposed between opposed air bags may prevent inflation of the air bags, thus keeping each air bag in an un-inflated (e.g., retracted) position and indicating the presence of product 18 detected by the sensor element 66.

In a fourth example construction, the moveable element 62 may include a contact member having a rigid body and a contact surface configured to engage and make contact with an adjacent wall (e.g., left 26 and right 28 side walls) of the container 12 (FIGS. 1 and 2). The driver element 64 may include a biasing element (e.g., a spring) configured to bias the contact member in the extended position and operably connected to the contact member. The contact member may be releasably secured in the retracted position. The actuator 68 may be a squeeze trigger operably connected to the biasing element. The operable connection 70 may include a cable connected between the trigger and the biasing element such that engagement of the trigger may release or disengage the biasing element to drive the contact member outward toward the container 12 (FIGS. 1 and 2). Product 18 (FIGS. 1 and 2) disposed between opposed contact members may prevent movement of the contact members, thus keeping each contact member in the retracted position and indicating the presence of product 18 detected by the sensor element 66.

In a fifth example construction, the moveable element 62 may include a contact member having a rigid body and a contact surface configured to engage and make contact with an adjacent wall (e.g., left 26 and right 28 side walls) of the container 12 (FIGS. 1 and 2). The driver element 64 may include an electric motor operably connected to the contact member. The actuator 68 may be a switch electrically connected to the motor. The operable connection 70 may include an electrical connection such that actuation of the switch may energize the motor to drive the contact member outward toward the container 12 (FIGS. 1 and 2). Product 18 (FIGS. 1 and 2) disposed between opposed contact members may prevent movement of the contact members, thus keeping each contact member in the retracted position and indicating the presence of product 18 detected by the sensor element 66.

The moveable members 62 may be dimensioned to contact at least a portion of an end of the product 18. For example, the moveable members 62 may include a length or width dimension greater than, equivalent to, or less than the diameter of the product 18. The moveable member 62 may include any geometric shape including, but not limited to rectangular, circular, square, or the like. However, the moveable members 62 may be of any size or shape depending on the size and shape of the products 18 housed within the container 12 (FIGS. 1 and 2).

In another example implementation, the moveable element 62 may be initially positioned in the extended position. The driver element 64 may include a biasing element (e.g., a spring) configured to bias the moveable member 62 in the extended position. The driver element 64 may apply the driving force F2 to the associated moveable element 62 to drive the moveable element 62 toward an adjacent wall (e.g., left side wall 26 or right side wall 28) of the container 12. Each moveable element 62 may either move to the retracted position or may remain in the extended position depending upon the presence of product 18 (FIGS. 1 and 2) disposed between opposed moveable elements 62. Product 18 (FIGS. 1 and 2) disposed between opposed moveable elements 62 may force each movable element 62 in the retracted position and indicating the presence of product 18 detected by the sensor element 66.

In another example implementation, the moveable elements 62 may be secured or locked into the retracted and extended positions following actuation of the driver element 64 such that when the product detector 14 is removed from the container 12, the position of the sensor assemblies 16 (e.g., representing presence of product 18 or presence of a void 60) may be visually counted. A locking mechanism (not shown) may be operably connected to the moveable element 62 to temporarily secure each moveable element 62 into the post-actuated position.

The moveable elements 62 may include rounded or beveled peripheral edges to allow the arms 42, 44 (FIGS. 1 and 2) to be positioned proximate the walls of the container 12 (e.g., left side wall 26 or right side wall 28) as the container 12 is received within the open region 48 through the opening 50 (FIGS. 3 and 4).

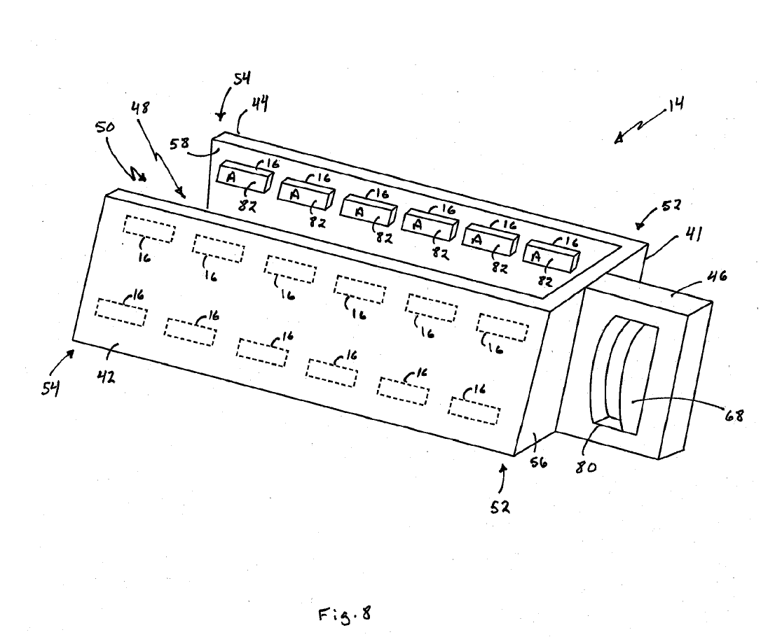

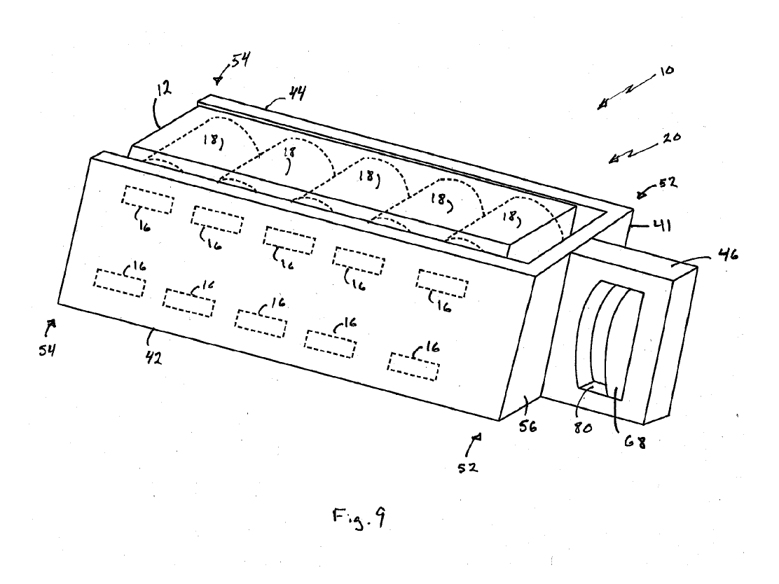

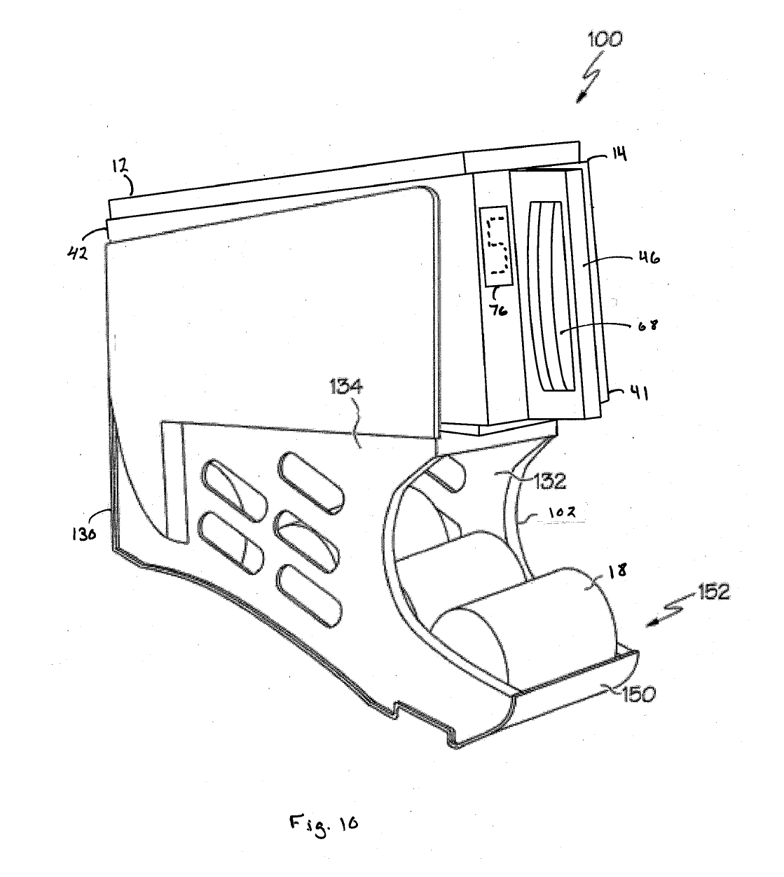

Referring to FIGS. 8 and 9, the handle 46 may include a grip 80 configured to be gripped by a human hand. The actuator 68 may be connected to the grip 80 for actuation of driver element 64. In an example construction, the grip 80 may be a U-shaped grip and the actuator 68 may be slidably connected within the grip 80, such that the actuator 68 (e.g., trigger) may be squeezed by a user. In another example construction, the grip 80 may be a pistol-type grip and the actuator 68 may be pivotably connected to the grip 80, such that the actuator 68 (e.g., trigger) may be squeezed by the user for actuation of driver element 64.

As shown in FIG. 8, the surface areas A of a contact surface 82 of each sensor assembly 16 (e.g., of the moveable element 62) may correspond to the surface area of an end of the product 18. In one construction, the surface area A of the contact surface 82 of each sensor assembly 16 may be at least 25 percent of the surface area of the end of the product 18. In another construction, the surface area A of the contact surface 82 of each sensor assembly 16 may be at least 50 percent of the surface area of the end of the product 18. In another construction, the surface area A of the contact surface 82 of each sensor assembly 16 may be at least 75 percent of the surface area of the end of the product 18. In another construction, the surface area A of the contact surface 82 of each sensor assembly 16 may be at least 100 percent of the surface area of the end of the product 18.

While the foregoing discussion and Figures are directed to a configuration in which the first and second arms 42, 44 and the plurality of opposed sensor assemblies 16 are positioned proximate the left and right side walls 26, 28, respectively, other parallel and opposed configurations of the first and second arms 42, 44 may be used to configure the plurality of opposed sensor assemblies 16 about opposing ends of product 18 housed within the container 12. In one alternative configuration, the first arm 42 and associated plurality of sensor assemblies 16 may be positioned proximate the front wall 22 (FIG. 3) of the container 12 and the second arm 44 and associated plurality of sensor assemblies 16 may be positioned proximate the rear wall 24 (FIG. 3) of the container 12. In another alternative configuration, the first arm 42 and associated plurality of sensor assemblies 16 may be positioned proximate the base wall 30 (FIG. 3) of the container 12 and the second arm 44 and associated plurality of sensor assemblies 16 may be positioned proximate the upper wall 32 (FIG. 3) of the container 12.

The disclosed system for measuring product quantity in a container 10 may be associated with a product dispensing system. Various product dispensing systems may be constructed (or modified) for use with the disclosed system for measuring product quantity in a container 10.

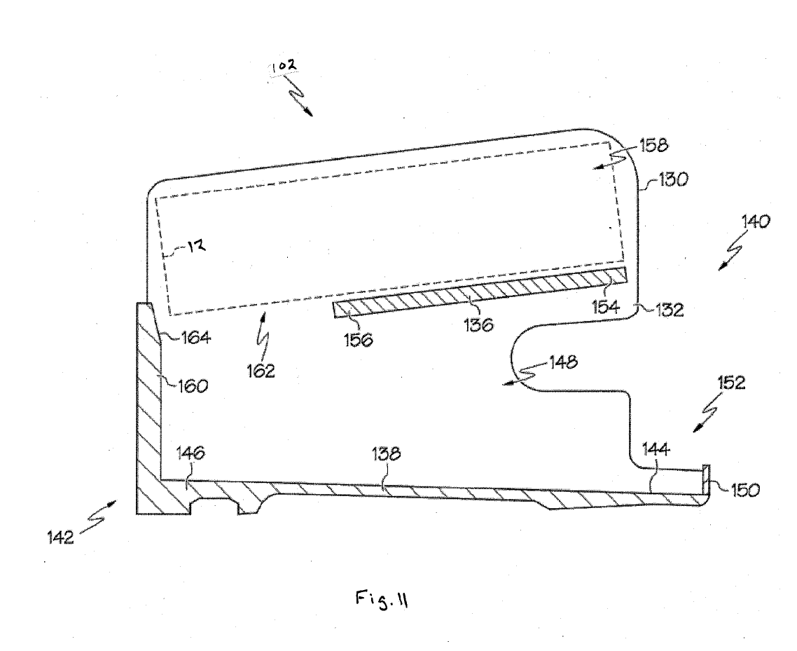

Referring to FIG. 10, one embodiment of the disclosed product dispensing system, generally designated 100, may include a container 12 and a dispenser 102. The container 12 may be mounted on the dispenser 102 such that products 18 initially housed in the container 12 may move to, and may be dispensed from, the dispenser 102.

Referring to FIGS. 10 and 11, the dispenser 102 may include a dispenser frame 130 that supports the container 12 in a desired configuration, such as a slightly declined, but generally horizontal configuration, as shown in FIG. 10. The container 12 may be positioned on the frame 130 of the dispenser 102 to allow products 18 (FIG. 10) to dispense from the container 12 (by way of the container opening 40 shown in FIG. 5) to the dispenser 102.

The frame 130 may include a first (e.g., right) side wall 132, a second (e.g., left) side wall 134 (FIG. 10), an upper support deck 136 and a lower support deck 138. The right side wall 132 may be laterally spaced from the left side wall 134, and may be generally parallel with the left side wall 134. The frame 130 may include a first (front) end 140 and a second (rear) end 142 longitudinally opposed from the front end 140.

The lower support deck 138 may laterally extend between the right and left side walls 132, 134, and may include a front end 144 that longitudinally extends toward the front end 140 of the frame 130 and a rear end 146 that longitudinally extends toward the rear end 142 of the frame 130. Therefore, the lower support deck 138 and the side walls 132, 134 may define a lower level 148 of the frame 130.

The lower support deck 138 may be inclined from the front end 144 to the rear end 146 (i.e., the rear end 146 may be elevated relative to the front end 144) such that products 18 (FIG. 10) deposited proximate the rear end 146 of the lower support deck 138 roll down to the front end 144 of the lower support deck 138 under the force of gravity.

A stop 150 may be positioned proximate the front end 144 of the lower support deck 138 to prevent products 18 from rolling beyond the front end 144 of the lower support deck 138. For example, the stop 150 may be connected to (e.g., integral with) the lower support deck 138, and may form an abrupt stop or an upward curve at the front end 144 of the lower support deck 138. Therefore, as shown in FIG. 10, the stop 150 may collect products 18 at the front end 144 of the lower support deck 138, thereby defining a product display area 152 at the front end 144 of the lower support deck 138.

The upper support deck 136 may laterally extend between the right and left side walls 132, 134, and may include a front end 154 that longitudinally extends toward the front end 140 of the frame 130 and a rear end 156 that longitudinally extends toward, but not to, the rear end 142 of the frame 130. Therefore, the upper support deck 136 and the side walls 132, 134 may define an upper level 158 of the frame 130.

The spacing between the rear end 156 of the upper support deck 136 and the rear end 142 of the frame 130 (e.g., rear wall 160 of the frame 130) may define a dispenser opening 162. The dispenser opening 162 may function as a chute to allow products 18 to drop (e.g., under the force of gravity) from the upper level 158, through the dispenser opening 162, and down to the lower level 148 of the frame 130.

The upper support deck 136 may be declined from the front end 154 to the rear end 156 (i.e., the front end 154 may be elevated relative to the rear end 156). Therefore, under the force of gravity, products 18 supported on the upper support deck 136 may roll down to the rear end 156 of the upper support deck 136, may pass through the dispenser opening 162 down to the lower level 148 of the frame 130 and, ultimately, may move to the product display area 152.

A rear wall 160 may be positioned at the rear end 142 of the frame 130 between the right and left side walls 132, 134. The rear wall 160 may serve as (or may include) a rear stop 164 that inhibits rearward horizontal movement of the container 12 along the upper support deck 136 beyond the rear wall 160.

Prior to dispensing products 18 by way of the dispenser 102, the container opening 40 (FIG. 5) may be formed in the container 12. The container opening 40 may be pre-formed in the container 12 and, therefore, no opening step may be required. If the container 12 includes a tear-away access panel, then the access panel may be separated (at least partially) from the container 12 to form the container opening 40.

While the container opening 40 may be manually formed prior to loading the container 12 onto the upper support deck 136 of the dispenser 102, an optional opening tool may be associated with the dispenser 102 to effect automatic formation of the container opening 40 upon loading the container 12 onto the upper support deck 136 of the dispenser 102. One product dispensing system having an opening tool is disclosed in greater detail in U.S. Pat. No. 7,922,437 to Loftin et al., which issued on Apr. 12, 2011, the entire contents of which are incorporated herein by reference. Another product dispensing system having an opening tool is disclosed in greater detail in U.S. patent application Ser. No. 13/032,734 filed on Feb. 23, 2011 by Gelardi et al., the entire contents of which are incorporated herein by reference.

As shown in FIG. 9, the container 12 may be positioned substantially (if not entirely) between the first arm 42 and second arm 44 such that opposed pairs of sensor assemblies 16 are proximate ends of product 18 disposed therebetween.

As shown in FIG. 10, in one implementation, the first and second arms 42, 44 of the product detector 14 may be fit between walls (e.g., left 26 and right 28 side walls) of the container 12 and first 132 and second 134 side walls of a product dispenser 102. The overall thickness dimension of the arms 42, 44 including the sensor assemblies 16 may be suitably sized to fit between left 26 and right 28 side walls of the container 12 and the side walls 132, 134 of a product dispenser 102, as illustrated in FIG. 10.

In another implementation of the disclosed product dispensing system 100, the sensor assemblies 16 of the disclosed system 10 (FIGS. 1 and 2) for measuring product quantity may be incorporated into the side walls 132, 134 (in the upper level 158) of the frame 130 of the dispenser 102. The actuator 68 may be incorporated into the frame 130 of the dispenser 102. Therefore, the sensor assemblies 16 of the side walls 132, 134 of the dispenser 102 may effectively engage the container 12 when the container 12 is loaded onto the upper support deck 136 of the dispenser 102.

Accordingly, the disclosed system and method for measuring product quantity in a container may accurately and consistently measure the number of products housed in a container without the need for opening and inspecting the container.

Although various embodiments of the disclosed system and method for measuring product quantity in a container have been shown and described, modifications may occur to those skilled in the art upon reading the specification. The present application includes such modifications and is limited only by the scope of the claims.

Having thus described certain particular embodiments of the invention, it is understood that the invention defined by the appended claims is not to be limited by particular details set forth in the above description, as many apparent variations thereof are contemplated. Rather, the invention is limited only be the appended claims, which include within their scope all equivalent devices or methods which operate according to the principles of the invention as described.

What is claimed is:

1. A system for measuring product quantity comprising:
a first plurality of sensor assemblies; and
a second plurality of sensor assemblies, said second plurality of sensor assemblies being laterally opposed to and aligned with said first plurality of sensor assemblies;
wherein opposed pairs of sensor assemblies are configured to detect a presence of a product disposed between said opposed pairs of sensor assemblies.

2. The system of claim 1 wherein each sensor assembly comprises:
a moveable element configured to move between a retracted position and an extended position;
a driver element operably connected to said moveable element and configured to drive said moveable element; and
a sensor element operably connected to said moveable element and configured to sense a condition of said sensor assembly.

3. The system of claim 2 wherein said condition of said sensor assembly is defined by a position of said moveable element.

4. The system of claim 2 wherein said condition of said sensor assembly is a pressure applied to said moveable element.

5. The system of claim 2 wherein said condition of said sensor assembly is a strain applied to said moveable element.

6. The system of claim 2 comprising:
an actuator operably connected to said plurality of sensor assemblies and configured to actuate said driver element; and
a display element electrically connected to said plurality of sensor assemblies and configured to display said product quantity.

7. A system for measuring product quantity comprising:
a container that defines an internal volume;
a plurality of products positioned in said internal volume; and
a product detector comprising:
a first plurality of sensor assemblies positioned proximate said container; and
a second plurality of sensor assemblies positioned proximate said container;
wherein opposed pairs of sensor assemblies are configured to detect a presence of said product disposed between said opposed pairs of sensor assemblies.

8. The system of claim 7 wherein said container comprises:
a front wall opposed from a rear wall;
a base wall opposed from an upper wall; and
a first side wall opposed from a second side wall.

9. The system of claim 8 wherein said container defines a container opening into said internal volume, and wherein said container opening is sized to allow at least one product of said plurality of products to pass therethrough.

10. The system of claim 8 wherein said product detector further comprises:
a first arm and a second arm laterally opposed to said first arm;
wherein said first plurality of sensor assemblies is disposed along said first arm and said second plurality of sensor assemblies is disposed along said second arm; and
wherein said first arm is positioned proximate said first side wall of said container and said second arm is positioned proximate said second side wall of said container.

11. The system of claim 9 wherein each sensor assembly comprises:
a moveable element configured to move between a retracted position and an extended position;
a driver element operably connected to said moveable element and configured to drive said moveable element; and
a sensor element operably connected to said moveable element and configured to transmit an output signal based upon a condition of said sensor assembly.

12. The system of claim 11 comprising an actuator operably connected to said plurality of sensor assemblies and configured to actuate said driver element of each of said sensor assemblies.

13. The system of claim 11 comprising a control element electrically connected to said plurality of sensor assemblies and configured to receive said output signal from said sensor element of each of said sensor assemblies and correlate said output signal to said product quantity.

14. The system of claim 13 comprising a display element electrically connected to said control element and configured to display said product quantity.

15. The system of claim 11 wherein said condition of said sensor assembly is defined by a position of said moveable element.

16. The system of claim 11 wherein said condition of said sensor assembly is defined by a pressure applied to said moveable element.

17. The system of claim 11 wherein said condition of said sensor assembly is defined by a strain applied to said moveable element.

18. The system of claim 7 comprising:
a dispenser frame having a front end and rear end, said dispenser frame comprising:
an upper support deck extending between said front end and said rear end; and
a lower support deck positioned below said upper support deck, said lower support deck defining a product display area;
wherein said container is positioned on said upper support deck.

19. The product dispensing system of claim 18 wherein said first plurality of sensor assemblies and said second plurality of sensor assemblies are connected to said dispenser frame.

20. A method for determining a number of products in a container, said method comprising the steps of:
positioning said container between a first plurality of sensor assemblies and a second plurality of sensor assemblies;
actuating said first and second plurality of sensor assemblies;
sensing a condition of opposed pairs of sensor assemblies; and
correlating said condition of said opposed pairs of sensor assemblies to said number of products in said container.
